(19) United States
(12) Patent Application Publication
(10) Pub. No.: US 2012/0079125 A1
(43) Pub. Date: Mar. 29, 2012

(54) SERVICE ORIENTED FRAMEWORK FOR COMMUNICATING WITH DEVICES IN A PROCESS CONTROL SYSTEM

(76) Inventor: Mark Nixon, Round Rock, TX (US)

(21) Appl. No.: 12/889,064

(22) Filed: Sep. 23, 2010

(51) Int. Cl. G06F 15/16

(52) U.S. Cl. 709/230

(57) ABSTRACT

A service oriented framework for communicating with devices in a process control system is disclosed. An example method to communicate with a device in a process control system disclosed herein comprises invoking a service to communicate with the device in the process control system, the service having a generic interface that is independent of a process control network protocol used to implement the process control system, translating the service into one or more network operations to implement the service, the network operations being specific to the process control network protocol used to implement the process control system, and using a network interface specific to the process control network protocol used to implement the process control system to communicate with the device in accordance with the one or more network operations.

### FIELD OF THE DISCLOSURE

This disclosure relates generally to process control systems and, more particularly, to a service oriented framework for communicating with devices in a process control system.

### BACKGROUND

Process control systems, like those used in chemical, petroleum or other processes, typically include one or more process controllers communicatively coupled to at least one client or operator workstation and to one or more field devices via analog, digital or combined analog/digital buses. The field devices, which may be, for example, valves, valve positioners, switches and transmitters (e.g., temperature, pressure and flow rate sensors), perform process control functions within the process such as opening or closing valves and measuring process control parameters. The controllers receive signals indicative of process measurements made by the field devices, process this information to implement a control routine, and generate control signals that are sent over the buses or other communication lines to the field devices to control the operation of the process. In this manner, the controllers execute and coordinate control strategies or routines using the field devices via the buses and/or other communication links communicatively coupling the field devices.

Information from the field devices and the controllers may be made available to one or more applications (e.g., routines, programs, etc.) as runtime data executed by the client/operator workstation (e.g., a processor-based system) to enable an operator to perform desired functions with respect to the process. Some of these functions may include viewing the current state of the process (e.g., via a graphical user interface), evaluating the process, modifying the operation of the process (e.g., via a visual object diagram), etc. Many process control systems also include one or more other client stations, also referred to as application stations. Typically, an application stations is implemented using a personal computer, workstation, or the like that is communicatively coupled to the controllers, operator workstations, and other systems within the process control system via a local area network (LAN). Each application station may execute one or more strategies, routines, or applications that perform campaign management functions, maintenance management functions, virtual control functions, diagnostic functions, real-time monitoring functions, safety-related functions, configuration functions, etc. within the process control system.

### SUMMARY

The example methods, apparatus and articles of manufacture described herein relate generally to process control systems and, more particularly, to a service oriented framework for communicating with devices in a process control system. In an example disclosed herein, a method to communicate with a device in a process control system includes invoking a service to communicate with the device in the process control system, the service providing a generic interface that is independent of a process control network protocol used to implement the process control system. The example method also includes translating the service into one or more network operations to implement the service, the network operations being specific to the process control network protocol used to implement the process control system. Furthermore, the example method includes using a network interface specific to the process control network protocol used to implement the process control system to communicate with the device in accordance with the one or more network operations.

In another example disclosed herein, a tangible article of manufacture stores machine readable instructions which, when executed, cause a machine to at least invoke a service to communicate with a device in a process control system, the service providing a generic interface that is independent of a process control network protocol used to implement the process control system. The machine readable instructions, when executed, also cause the machine to at least translate the service into one or more network operations to implement the service, the network operations being specific to the process control network protocol used to implement the process control system. The machine readable instructions, when executed, further cause the machine to at least use a network interface specific to the process control network protocol used to implement the process control system to communicate with the device in accordance with the one or more network operations.

In still another example disclosed herein, an apparatus to communicate with field devices in process control systems includes a processor to implement a service oriented framework for communicating with a plurality of field devices in a plurality of process control systems implemented using a plurality of different process control network protocols. In some examples, the service oriented framework includes a service layer implementing a plurality of services to communicate with the plurality of field devices, each service providing a respective generic interface that is independent of any of the plurality of process control network protocols used to implement the plurality of process control systems. In some examples, the service oriented framework also includes a plurality of translation layers, each respective translation layer to translate each service in the plurality of services into a respective sequence of network operations to implement the respective service, the respective sequence of network operations being specific to a particular process control network protocol associated with the respective translation layer. In some examples, the service oriented framework further includes a plurality of network layers associated respectively with the plurality of translation layers to provide a plurality of network interfaces specific to each of the plurality of process control network protocols used to implement the plurality of process control systems. The example apparatus also includes an interface to communicatively couple an application implemented by a client device with the service layer implemented by the processor.

### BRIEF DESCRIPTION OF THE DRAWINGS

FIG. 1 is a block diagram illustrating an example process control environment including a field device integration server to implement a service oriented framework for communicating with devices in a process control system.

FIG. 2 is a block diagram of an example service oriented framework that may be implemented by the field device integration server of FIG. 1.

FIG. 3 illustrates example services that may be provided by the service oriented framework of FIG. 2.

FIG. 4 is a block diagram of an example field device integration server that may be used to implement the process control environment of FIG. 1.

FIG. 5 is a block diagram of an example client device that may be used to implement the process control environment of FIG. 1.

FIG. 6 is a flowchart representative of an example process for implementing an example service oriented framework in the process control environment of FIG. 1.

FIG. 7 is a flowchart representative of an example process for implementing service layer processing in the service oriented framework process of FIG. 6.

FIG. 8 is a flowchart representative of an example process for implementing translation layer processing in the service oriented framework process of FIG. 6.

FIG. 9 is a flowchart representative of an example process for implementing network layer processing in the service oriented framework process of FIG. 6.

FIG. 10 is a flowchart representative of an example operation of the service oriented framework of FIG. 2.

FIG. 11 is a block diagram of an example processing system that may execute example machine readable instructions used to implement some or all of the processes of FIGS. 6-10 to implement the service oriented framework of FIG. 2 in the process control environment of FIG. 1.

### DETAILED DESCRIPTION

Although the following describes example methods, apparatus and articles of manufacture including, among other components, software and/or firmware executed on hardware, it should be noted that these examples are merely illustrative and should not be considered as limiting. For example, it is contemplated that any or all of the hardware, software, and firmware components could be embodied exclusively in hardware, exclusively in software, or in any combination of hardware and software. Accordingly, while the following describes example methods, apparatus and articles of manufacture, persons of ordinary skill in the art will readily appreciate that the examples provided are not the only way to implement such methods, apparatus and articles of manufacture. For example, while the example methods, apparatus and articles of manufacture are described in connection with implementing a service oriented framework for communicating with devices in a process control system, the example methods, apparatus and articles of manufacture are more generally applicable and may be implemented for use in any automation system, batch processing system, manufacturing system, industrial control system, safety instrumented system, etc.

Many different types of process control network protocols can be used to implement process control systems. Examples of such process control network protocols include, but are not limited to, the Foundation Fieldbus protocol, the Profibus protocol, the HART protocol, etc. As noted above, a process control system can employ one or more client applications executing on one or more client workstations to process information and interact with field devices in the process control system. However, in prior process control systems, such client applications are typically targeted to the particular process control network protocol used to implement a particular process control system. As such, client applications used in prior process control systems may need to be revised, and even rewritten, when a different (e.g., new) process control network protocol is employed in the process control system, and these prior client applications may not be portable across different process control systems employing different process control network protocols.

In contrast, the example methods, apparatus and articles of manufacture described herein implement a service oriented framework for communicating with devices in a process control system that enables a client application (e.g., a process control application) to be independent of any particular process control network protocol(s) used to implement the process control system(s) in which the client application is employed. In some examples, the service oriented framework is implemented in the context of the field device integration (FDI) standard. An example service oriented framework described herein includes a service layer, one or more translation layers, and one or more network layers associated respectively with the one or more translation layers. In such an example, the service layer implements one or more process control services to communicate with one or more field devices in one or more process control systems. Each service provides a generic interface that is independent of any process control network protocol used to implement any process control system in which the field device(s) can reside. In other words, the services implemented by the service layer are network protocol agnostic. Examples of process control services implemented by the service oriented framework include, but are not limited to: (1) a service to send a message to a field device and to receive a corresponding response from the device; (2) a service to subscribe to published data returned by a field device; (3) a service to receive events returned by a field device; (4) a service to obtain information describing the process control system and a group of field devices implementing the process control system; (5) a service to write control parameter values to a field device, etc.

The one or more translation layers included in the example service oriented framework are each targeted to a respective process control network protocol. As such, a particular translation layer translates each service provided by the service layer into a respective sequence of network operations to implement the respective service, where the respective sequence of network operations is specific to a particular process control network protocol associated with the particular translation layer. In some examples, a translation layer reads a device description for a field device with which a service is to communicate to prepare the particular sequence of network operations used to implement the service. In some examples, the a translation layer additionally or alternatively maintains a state of a particular sequence of network operations used to implement a particular service to track the sequence of network operations as they are performed to implement the service.

The one or more network layers included in the example service oriented framework are also each targeted to a respective process control network protocol. For example, a particular network layer provides a network interface for an associated translation layer that is specific to the particular process control network protocol supported by the translation layer. The network interface enables communication transactions (e.g., commands, responses, etc.) to be exchanged with one or more field devices supporting the particular process control network protocol in accordance with (e.g., to perform, to implement, etc,) the particular sequence of network operations determined by the translation layer to implement the particulars service.

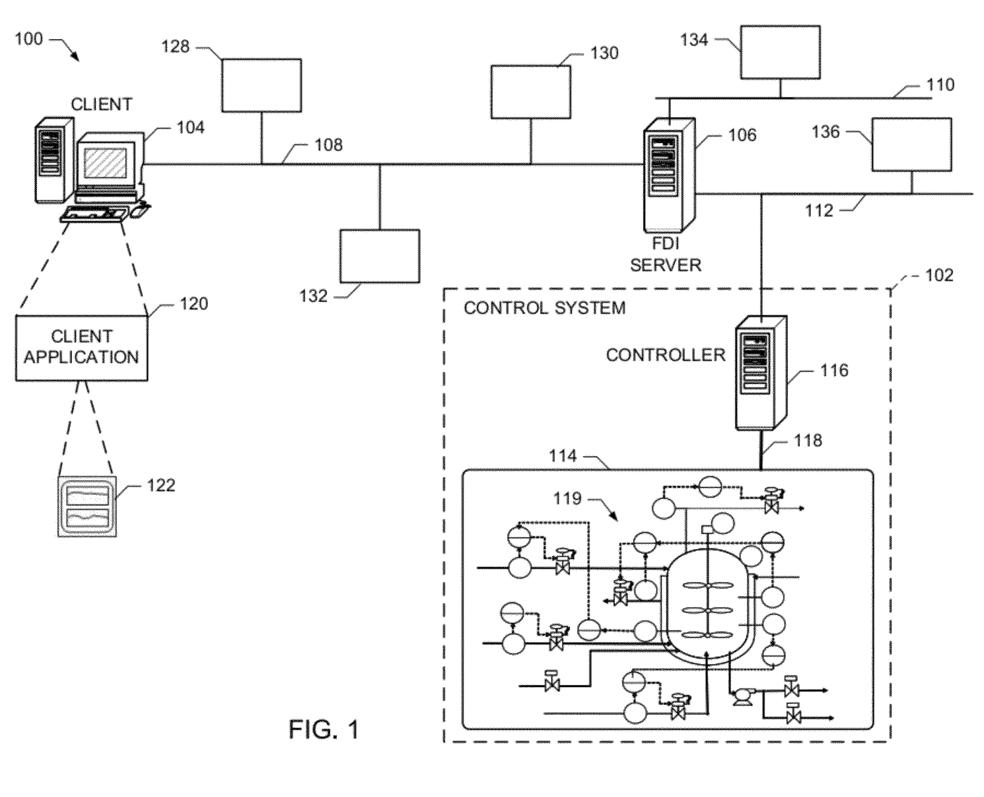

Turning to the figures, FIG. 1 is a block diagram illustrating an example process control environment 100 including a FDI server 106 to implement a service oriented framework for communicating with field devices in an example process control system 102. The example control environment 100 may include additional clients (not shown) that may be communicatively coupled to the process control system 102 and/or other control systems (not shown).

A client 104 (e.g., a terminal, a workstation, a personal computer, etc.), the example control system 102, and/or the field device integration (FDI) server 106 communicate using an FDI standard. The FDI server 106 interfaces devices on different networks operating using different standards, including HART, Foundation Fieldbus, and/or Profibus. In general, FDI provides specifications to allow device manufacturers and/or suppliers to build tool sets that can be used by customers to uniformly manage devices, regardless of the standard to which the devices were originally intended and/or built. FDI includes a textual device description method that allows a text-based file (e.g., an XML file) in a standard Electronic Device Description Language (EDDL) to describe a device, methods provided by the device, measurement and device parameters supported by the device, configuration information for the device, and/or interactions that users can have with the device.

As described in greater detail below, the FDI server 106 implements a service oriented framework based on a message bus architecture and a service oriented architecture. The message bus architecture provides a standard method for applications (such as the application 120 executing on the client 104 as described in greater detail below) to communicate with the service oriented framework. The message bus architecture resembles a message bus that sends and receives messages via communication channels. The message bus architecture allows applications to communicate with process control controllers, servers, devices and/or other applications without necessarily knowing all of the specific details about the internal operations of the controllers, servers, devices and/or other applications.

In addition to the message bus architecture, the service oriented architecture provides process control functionality as a set of services. Under such a service oriented architecture, network services that a specific device supports are summarized in a device description associated with the device. Services are invoked through interfaces implemented by message based interactions that are defined as part of the FDI standard. Because services are invoked through message based interactions, the locations of the service requester and service provider can be separated and, thus, distributed within the process control environment 100.

Combining the message bus architecture and the service oriented architecture into the service oriented framework can provide several benefits, under at least some circumstances. For example, applications can be run in different environments (e.g., an application executing on a Microsoft Windows™ host may interface with a process control embedded device using one of several process control network protocols). As another possible benefit, not all devices need to support all services. And yet another possible benefit, services allow higher level applications to be implemented independently of the actual process control network (e.g., bus) protocol.

The example client 104 and the example FDI server 106 are in communication via a first communication bus 108. The FDI server 106 connects the communication bus 108 to other communication buses 110, 112, which may be of the same type or of different types than the communication bus 108. The FDI server 106 is also in communication with the control system 102 via the communication bus 112. Thus, the client 104 may communicate with any of the devices in the control system 102 via the FDI server 106 and the appropriate communication buses 108 and 112.

In some examples, the communication buses 108-110 may be implemented using a local area network (LAN) protocol (such as Ethernet), a wireless fidelity (Wi-Fi) protocol (e.g., based on the Institute of Electrical and Electronics Engineers (IEEE) 802.11 family of standards), a cellular communication network, the Internet, etc., and the communication bus 112 may be implemented to be compliant with the Foundation Fieldbus protocol, the Profibus protocol, and/or the HART protocol. Additionally or alternatively, one or more of the communication buses 108-110 may be implemented to be compliant with the Foundation Fieldbus protocol, the Profibus protocol, and/or the HART protocol. Additionally or alternatively, the communication bus 112 may be implemented to be compliant with a LAN protocol (such as Ethernet), a Wi-Fi protocol (e.g., based on the IEEE 802.11 family of standards), a cellular communication network, the Internet, etc.

The example control system 102 may include any type of manufacturing facility, process facility, automation facility, and/or any other type of process control structure or system. In some examples, the control system 102 may include multiple facilities located at different locations. Additionally, although the example control system 102 is associated with a process control subsystem 114, the control system 102 may include additional process control subsystems.

The example process control subsystem 114 is communicatively coupled to a controller 116 via a data bus 118. The process control subsystem 114 may include any number of field devices 119 (e.g., input and/or output devices) as shown. The field devices 119 may include any type of process control component that is capable of receiving inputs, generating outputs, and/or controlling a process. For example, the field devices 119 may include input devices such as, for example, valves, pumps, fans, heaters, coolers, and/or mixers to control a process. Additionally, the field devices 119 may include output devices such as, for example, thermometers, pressure gauges, concentration gauges, fluid level meters, flow meters, and/or vapor sensors to measure portions of a process. The input devices may receive instructions from the controller 116 to execute a specified command and cause a change to the process. Furthermore, the output devices may measure process data, environmental data, and/or input device data and transmit the measured data to the controller 116 as process control information (e.g., process data). This process data may include the values of variables (e.g., measured process variables and/or measured quality variables) corresponding to a measured output from each field device 119.

In the illustrated example of FIG. 1, the example controller 116 may communicate with the field devices 119 within the process control subsystem 114 via the data bus 118. The data bus 118 may be coupled to communication components within the process control subsystem 114. The communication components may include I/O cards to receive data from the field devices 119 and convert the data into a communication medium capable of being received by the example controller 116. Additionally, these I/O cards may convert data from the controller 116 into a data format capable of being processed by the corresponding field devices 119. In an example, the data bus 118 may be implemented using the Fieldbus protocol or other types of wired and/or wireless communication protocols (e.g., Profibus protocol, HART protocol, etc.).

The controller 116 is communicatively coupled to the FDI server 106 via any wired and/or wireless connection. In some examples, the connection may include a firewall and/or other security mechanism(s) to limit access to the controller 116. The controller 116 may transmit process data to the FDI server 106 upon the controller 116 receiving the process data from the process control subsystem 114. In other examples, the controller 116 may transmit process data to the FDI server 106 at periodic time intervals (e.g., every minute, hour, day, etc.). Alternatively, the FDI server 106 may request process data from the controller 116.

Upon receiving the process data, the example FDI server 106 of FIG. 1 stores the process data within a file system (not shown). The file system may be arranged in a hierarchical manner with directories and/or sub-directories based on the devices 119 within the process control subsystem 114 and/or based on a routine (e.g., application and/or algorithm) operating within the controller 116 to manage the process control subsystem 114. In other examples, the file system may be arranged by an operator of the control system 102. The process data may be stored to a parameter within the associated directory and/or sub-directory. In some examples, the parameter may be a variable associated with a routine operating on the controller 116 or associated with a field device output within the process control environment 100. The parameter may include metadata that describes the type of process data associated with the parameter.

The example client 104 may be associated with an individual that may be authorized to read, write, and/or subscribe to process data associated with the process control environment 100. The client 104 may also be associated with personnel associated with the control system 102 that may access the process control environment 100 from a remote location. The client 104 may access the process control environment 100 via the FDI server 106 using any wired and/or wireless communication medium (e.g., the Internet).

The example FDI server 106 is capable of formatting the process data such that the process data is viewable by a user of a client application 120 operating on the client 104. The example of FIG. 1 shows the client application 120 displaying process data in an interface 122. For example, the client application 120 may include a web client display application. The FDI server 106 may format process data for a web server application by creating a webpage and/or accessing a template webpage and placing or embedding the data fields within the webpage. The interface 122, via a web browser, may then display the process data by accessing the webpage hosted in the FDI server 106 using hypertext markup language (HTML) requests and responses. Alternatively, the FDI server 106 may format the process data for a client display application by initializing a web application (e.g., ActiveX, Adobe Flash™ and/or Silverlight™) at the client application 120 that may be executable within a web browser (e.g., the interface 122) or may be native to the client 104 (e.g., a Windows® operating system application, an application plug-in). In some examples, the FDI server 106 associates the process data with the corresponding data fields prior to transmitting the process data to the client application 120. Upon receiving the process data, the client application 120 creates (e.g., renders) a display within the web browser (e.g., the interface 122) to view the process data within the corresponding data fields.

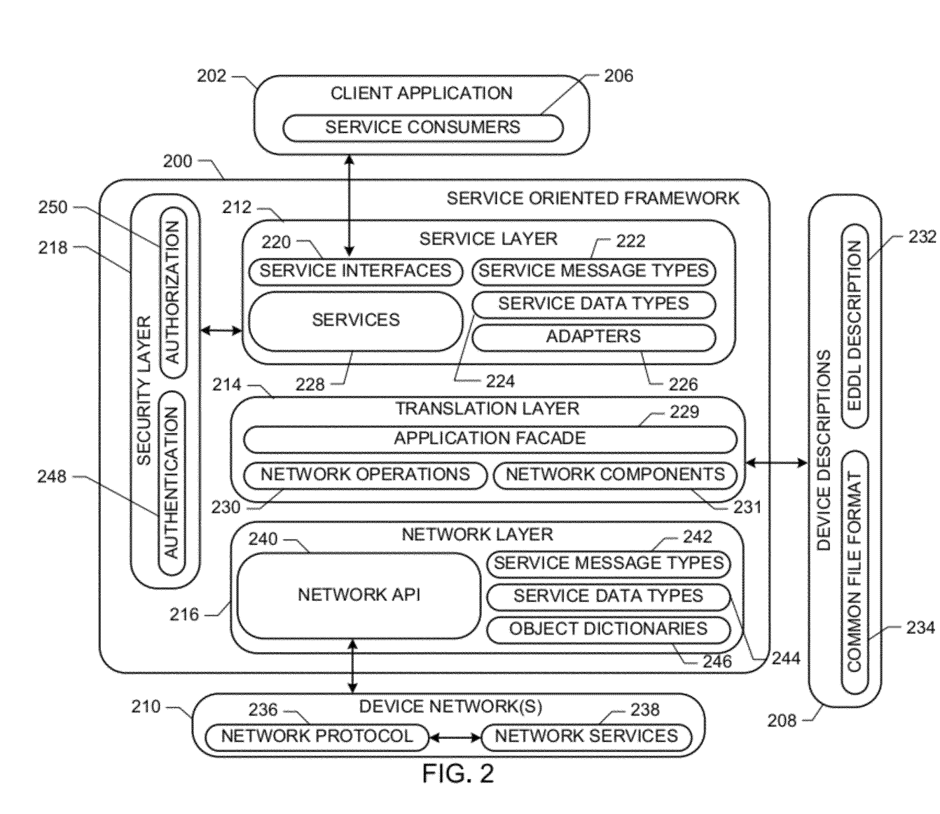

FIG. 2 is a block diagram of an example service oriented framework 200 that may be implemented, at least in part, by the example FDI server 106 of FIG. 1. As illustrated in FIG. 2, the service oriented framework 200 is in communication with a client application 202, device descriptions 208, and one or more device networks 210. The service oriented framework 200 includes a service layer 212, a translation layer 214, a network layer 216, and a security layer 218

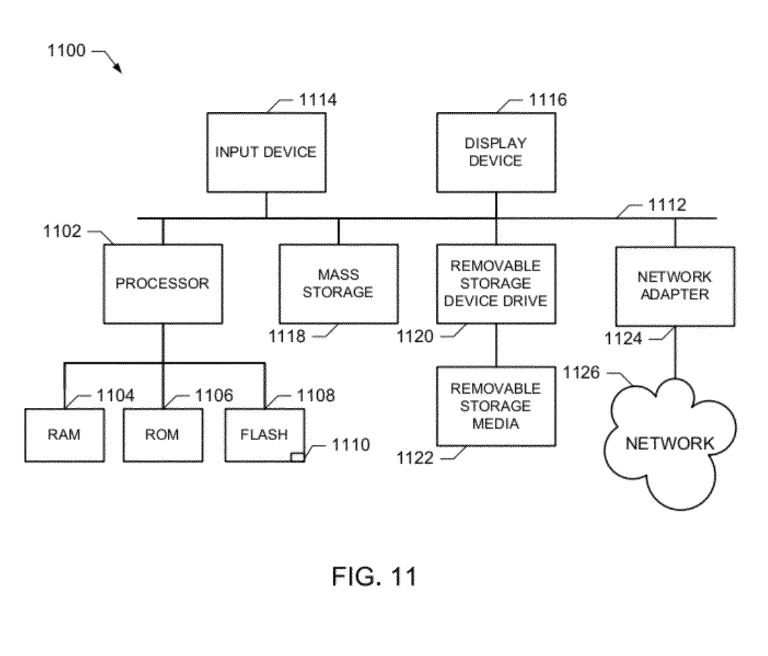

The example client application 202 of FIG. 2 is an application for configuring devices, an application for performing device calibration and diagnostics, and/or an application for reading measurement values and events from devices located in one or more device networks. The client application 202 can include a user interface (UI) implemented according to a rich client model or a rich Internet model. For example, in a rich client model, the UI employs a Microsoft Windows™ or similar application style. In a rich Internet model, the UI employs a web style client, such as a web browser interface or web browser plug-in interface. As illustrated in FIG. 2, the client application 202 includes service consumers 206, which may request and consume services from the service layer 212. The client application 202, which may correspond to the application 120 of FIG. 1, may be implemented using computer-readable instructions executed on, for example, the example client 104 of FIG. 1 and/or the example processing system 1100 of FIG. 11. The client application 202 communicates with the device network(s) 210, which may correspond to the process control subsystem 114, via the service oriented framework 200. Although the service oriented framework 200 is described as being implemented by the FDI server 106, the example service oriented framework 200 and/or selected portions of the framework 200, may alternatively be implemented on one or more, or any combination of, the client(s) 104, server(s) 106, controller(s) 116, and/or device(s) 128-136 on the networks 108, 110, and 112.

The service layer 212 includes service interfaces 220, service message types 222, service data types 224, adapters 226, and services 228. The example services 228 provided by the service layer 212 support access to the device descriptions 208 and the device network(s) 210. The services 228 are exposed as service contracts, which allow applications and/or devices to request the particular services 228 needed to execute desired capabilities or functions. In some examples, changes to the service contracts to include new functions implemented by a service, and/or to include new message and data types, may not be backward compatible with the existing service contracts.

In the illustrated example, the service layer 212 is accessed through the service interfaces 220, which provide message based interfaces to the services 228. The service layer 212 manages service requests from applications and/or devices and translates service contracts for use by the client applications 202. When passing messages between a service and a service consumer, one or more adapters 226 may be used to transform the messages into formats that the respective service consumers can understand.

Access to the service layer 212 is defined by policies. Policies provide a way for the service consumers to determine any connection and/or security requirements for accessing services, and/or any other details related to requesting services.

The example translation layer 214 translates the network independent services provided by the service layer to support specific process control network protocols (such as HART, Fieldbus, Profibus, which are also referred to herein as device network protocols) used to implement the device network(s) 210 (or, more generically, the process control system(s)) containing the device(s) with which communication is desired. The translation layer 214 includes an application façade 229 to translate each network independent service 228 provided by the service layer 212 into a respective sequence of network operations 230 to implement the respective service. The sequence of network operations 230 determined by the application façade 229 for a particular service 228 is specific to a particular process control network protocol 236 associated with the translation layer 214, and also to the particular network component(s) 231 (e.g., field device(s)) with which the service 228 is to communicate. The translation layer 214 also maintains a state (e.g., order, time, etc.) of execution of the sequence of network operations 230 used to implement a particular service to track the sequence of network operations 230 as they are performed to implement the service 228.

The translation layer 214 receives information about devices (e.g., the network components 231) from the device description files 208 which are read, for example, upon startup. The device description files 208 include the information about devices in an electronic device description language (EDDL) 232 and/or in a common file format 234. For example, EDDL files 232 represent textual descriptions and logic defining device behavior that are generated by the respective manufacturers of the field devices contained in the process control system 102 of FIG. 1. The EDDL files 232 can resemble digital datasheets of the devices contained on the process control system 102 of FIG. 1. Compared to conventional programming languages, the flexibility of EDDL elements is limited and specific to device description. However, the simplicity of the EDD language allows for easy and efficient development of EDD device descriptions, provides independence from hardware and operating system platforms, results in a uniform philosophy for device operation, and yields high robustness through interpretation. Generally, EDDL technology is used for devices with low to average complexity

The common file format 234 stores information about devices and/or applications, and the files may be exchanged between systems, tool sets, applications, and/or other devices. In some examples, the common file format 234 uses a schema that includes extensible markup language (XML) which is flexible and allows virtually unlimited description using tags.

The network layer 216 includes data access functionality to interact with one or more of device networks used to implement the process control system 102 of FIG. 1. In the illustrated example, the network layer 216 includes a network application programming interface (API) 240 that supports various network message types 242, network data types 244 and possibly one or more object dictionaries 246 specific to a particular process control network protocol 236. The example framework 200 may include multiple network layers 216 and associated translation layers 214, where each translation layer 214 and associated network layer 216 is specific to a particular device network protocol 236 (also referred to as a process control system protocol, such as HART, Fieldbus, and Profibus) implementing a particular device network 210 (or, more generally, a particular process control system). Accordingly, the example framework 200 and the network application layer 216 do not require any changes to these protocols.

The device networks 210 interface with the field devices implementing process control system(s) (e.g., the process control system 102 of FIG. 2) in accordance with respective network protocols 236 and network services 238 to provide the example framework 200 with the ability to configure process control field devices, access device diagnostics, transfer measurement values, transfer alarms and events, and/or other communication and control capabilities. Some example capabilities supported by the service oriented framework 200 include requests and/or responses, publishing and/or subscribing, transmitting events, maintaining a directory of applications and/or devices, and/or writing commands to devices. The service oriented framework 200 provides the client application 202 with access to these capabilities via the service layer 212. For example, the service oriented framework 200 may have services defined for request/response, publish/subscribe, events, directory, and write capabilities.

In some example, the service oriented framework 200 employs an asynchronous call model for invoking services. Using asynchronous calls avoids blocking client processes. In some examples, one or more separate processing threads for performing background operations are also used to poll for data from the field devices. As such, longer-running operations, such as reading data from field devices, can be handled with a background thread and asynchronous execution to prevent a processing thread implementing the UI application from being blocked (e.g., as can happen with prior applications). In some examples, service calls use bindings that include security information to enable the client-server connection to be authenticated. To protect sensitive information and communication channels, Internet Protocol Security (IPSec) and Secure Sockets Layer (SSL) can be used to secure communication channels, such as the channel between the client device 104 and the FDI server 106. Encryption to protect data and digital signatures to detect data tampering can also be employed, with an option to turn these capabilities on and off.

In an example operation, the client application 202 uses the FDI standard and invokes a service 228 having a generic (e.g., network independent) interface 220 to request reading the pressure from a device, such as a pressure transmitter. Upon receiving the request, the service layer 212 transfers the request to the translation layer 214. The translation layer 214 generates a command specific to the device network to which the pressure transmitter is connected and transmits the command via the network application layer 216. For example, if the device network is a HART network, the client application 202 sends a command to the pressure transmitter. In contrast, if the device network is a Fieldbus network, the client application 202 reads or requests an object-dictionary entry. The device network transports the request to the pressure transmitter and returns the response from the device to the translation layer 214 via the network application layer 216. The translation layer 214 then converts the response to a generic response format that is understandable by the client application 202. In some other examples, the client application 202 requires a specific format for the response. In these cases, the client application 202 may request that a specific adapter 226 be invoked when the response is returned to the client application 202.

In some cases it may be necessary to restrict access to the device networks. To support this requirement the service oriented framework 200 includes the security layer 218 to provide one or more authentication modules 248 and/or authorization modules 250. The implementation of an authentication module 248 to authenticate applications 202 with the framework 200 may be dependent on the type of service host that is being used. Thus, the service oriented framework 200 allows one or more security layers 218 to be incorporated into the framework 200. For example, if the service oriented framework 200 is hosted in Internet Information Services (IIS), the authentication support provided by IIS can be used. If the service is hosted by a Windows™ Service, a message-based or transport-based authentication can be used.

In some examples, the service oriented framework 200 provides authorization of user access. In these cases an authorization module 250 can be used to provide access permissions on resources for users, groups, and roles.

In some examples, implementation of the translation layer 214 is split across the FDI server 106 and the client device 104 to, for example, improve performance of the process control application 202. In such an example, the client device 104 can implement the portions of the transaction layer 214 that do not contain sensitive information, whereas the FDI server 106 can implement the portions of the transaction layer 214 that do contain sensitive information.

In some examples, the FDI server 106 and/or the client device 104 employ caching to, for example, improve performance of the process control application 202. For example, the client device 104 can cache components of the service oriented framework 200 (e.g., such as the service(s) 228) obtained from the FDI server 106. Additionally or alternatively, the FDI server 106 can cache the device description(s) 208 after they are read from, for example, an external memory, the field devices themselves, etc. Additionally or alternatively, the FDI server 106 can cache data returned from field devices and/or data to be written to field device(s) until such data is to be returned to the application 202 or written to the field device(s), as appropriate.

In some examples, program composition is employed in the service oriented framework 200 to allow applications to be extended more easily without reimplementation or redeployment of the entire application. This can be achieved by implementing applications from a number of modules and designing the components to be loosely coupled.

In some examples, the service oriented framework 200 supports exception management and logging. For example, errors such as validation messages can be logged on the FDI server 106 for use by operations staff and monitoring systems. Exception management can also cover both asynchronous exceptions as well as exception coordination between client and server code. In terms of logging, access to the client file system is not available in Silverlight applications, and execution of the client and the server often proceed asynchronously. Thus, some or all of the following information is included in log files transferred from the client-side are to the server-side: (1) the user associated with each logged entry; (2) the machine associated with log entry; (3) a mechanism to combine related client and server log files; (4) critical errors and exceptions, etc.

In some examples, the process control application(s) 202 are implemented to utilize the built-in media capabilities of the platform, such as the client device 104. For example, the following guidelines can be followed: (1) the process control application 202 is designed to utilize graphics capabilities already provided by the client device 104, because the interface to the service oriented framework 200 is independent of any particular process control network protocol; and (2) native graphics and/or vector graphics are utilized to, for example, improve application performance.

In some examples, the service interface(s) 220 providing the interface between the application 202 executing on the client device 104 and service oriented framework 200 executing on the FDI server 106 support client devices 104 that are fixed or mobile, such as rich desktops, smart handhelds, less capable handhelds, etc. Thus, the service interface(s) 220 may be implemented to support, for example, UI descriptions for both rich and mobile interfaces that enable navigation used as part of the mobile interface to be similar to a rich UI.

In some examples, the service oriented framework 200 supports application(s) 202 that employ web-style interfaces. In such examples, data binding is used to display data in, for example, tabular and multi-row data presentations. This can reduce the code required to implement presentation of device date, which can simplify development and reduce coding errors. Data binding also enables automatic synchronization of data in different views or forms. Use of two-way binding also allows a user to update the presentation data. Additionally, navigation button events can be trapped to avoid unintentional navigation away from the application or web page.

As noted above, the translation layer 214 stores the state of the sequence of network operations 230 determined for implementing a particular service 228 invoked by the client application 202. Because one or more applications 202 can invoke multiple services 228 concurrently, the translation layer 214 is configured to store the state information for different sequences of network operations 230 for different services 228 executing concurrently in isolated storage (not shown) such that the state of one sequence cannot be corrupted by another sequence.

As noted above, the service oriented framework 200 includes the security layer 218 to provide one or more authentication modules 248 and/or authorization modules 250. In some examples, an authentication module 248 supports validation of the application 202, the service oriented framework 200, the device description files 208, etc., to ensure that these components are interoperating properly. For example, client-side validation of the application 202 can be used to ensure that the proper UI is being presented to a user. Server-side validation can be used to validate input from data sources, such as data provided by the application 202 and/or the field devices. For example, server-side validation mechanisms can be used to constrain, reject, and/or sanitize data, with input data being checked for length, range, format, type, etc. In some examples, isolated storage (not shown) is used to store validation rules specific to a particular application 202 and/or client device 104.

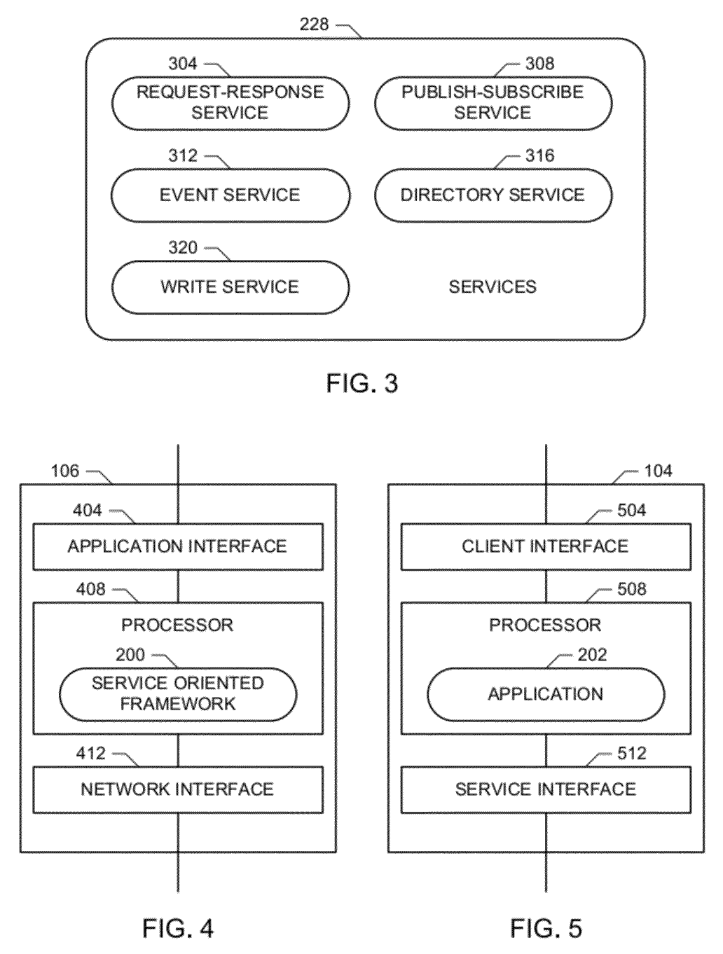

FIG. 3 is a block diagram illustrating examples services 228 that may be provided by the example service oriented framework 200 of FIG. 2. The example services 228 of FIG. 3 include an example request-response service 304 for an application (e.g., the client application 202) to send a message to a field device and to receive a corresponding response from the device. The example services 228 of FIG. 3 also include an example publish-subscribe service 308 for an application (e.g., the client application 202) to subscribe to published data returned by a field device. The example services 228 of FIG. 3 further include an example event service 312 for an application (e.g., the client application 202) to receive events returned by a field device. Additionally, the example services 228 of FIG. 3 include an example directory service 316 for an application (e.g., the client application 202) to obtain information describing one or more device networks 210 (e.g., or, more generally, one or more associated process control systems 102) and a group of field devices interconnected by the one or more device networks 210 (e.g., and, thus, implementing the one or more associated process control systems 102). The example services 228 of FIG. 3 also include an example write service 320 for an application (e.g., the client application 202) to write control parameter values to a field device. In some example, the write service 320 can support various access restrictions (e.g., such as to restrict writes to only authorized users).

FIG. 4 is a block diagram of an example implementation of the FDI server 106 of FIG. 1. The FDI server 106 of the illustrated example includes an example application interface 404 to interface with an application (e.g., the client application 202 of FIG. 2 and/or the client application 120 of FIG. 1). For example, the application interface 404 can implement the message-based service interfaces 220 defined by the service message types 222 and the service data types 224, which are independent of any process control network protocol. Additionally, the application interface 404 can be implemented to communicatively couple with applications executing on the FDI server 106 itself, and/or on other client devices (e.g., such as the client 104 of FIG. 1).

The FDI server 106 of FIG. 4 also includes an example processor 408 to execute machine readable instructions to implement some or all of the service oriented framework 200 of FIG. 2. The processor 408 may be implemented using any type of processor or processors, such as one or more of the processors 1102 included in the processing system 1100 of FIG. 11, which is described in greater detail below.

The FDI server 106 of FIG. 4 further includes an example network interface 412 to interface with one or more device networks implementing one or more process control systems. As such, the network interface 412 can support one or more of the process control network protocols 236 described above.

FIG. 5 is a block diagram of an example implementation of the client device 104 of FIG. 1. The client device 104 of the illustrated example includes an example client interface 504 to interface with other clients executing other process control applications (e.g., such as other client applications 202 of FIG. 2 and/or other client application 120 of FIG. 1). For example, the client interface 404 can any type of communication protocol and/or inter-process messaging for communicating between applications executing on the same or different devices.

The client device 104 of FIG. 5 also includes an example processor 508 to execute machine readable instructions to implement one or more applications 202 that are to interface with service oriented framework 200 of FIG. 2. The processor 508 may be implemented using any type of processor or processors, such as one or more of the processors 1102 included in the processing system 1100 of FIG. 11, which is described in greater detail below.

The client device 104 of FIG. 5 further includes an example service interface 512 to interface with the FDI server 106 of FIG. 1 and/or 4 that is implementing the service oriented framework 200. As such, the service interface 512 is the counterpart of the application interface 404 of FIG. 4, and can implement the message-based service interfaces 220 defined by the service message types 222 and the service data types 224 of the service oriented framework 200, which are independent of any process control network protocol.

While example manners of implementing the FDI server 106 and the client device 104 of FIG. 1 have been illustrated in FIGS. 4-5, respectively, one or more of the elements, processes and/or devices illustrated in FIGS. 4-5 may be combined, divided, re-arranged, omitted, eliminated and/or implemented in any other way. Further, the example application interface 404, the example processor 408, the example network interface 412, the example client interface 504, the example processor 508, the example service interface 512 and/or, more generally, the example FDI server 106 of FIG. 4 and/or the example client device of FIG. 5 may be implemented by hardware, software, firmware and/or any combination of hardware, software and/or firmware. Thus, for example, any of the example application interface 404, the example processor 408, the example network interface 412, the example client interface 504, the example processor 508, the example service interface 512 and/or, more generally, the example FDI server 106 and/or the example client device 104 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended apparatus claims are read to cover a purely software and/or firmware implementation, at least one of the example FDI server 106, the example client device 104, the example application interface 404, the example processor 408, the example network interface 412, the example client interface 504, the example processor 508 and/or the example service interface 512 are hereby expressly defined to include a tangible computer readable medium such as a memory, digital versatile disk (DVD), compact disk (CD), etc., storing such software and/or firmware. Further still, the example FDI server 106 of FIG. 4 and/or the example client device 104 of FIG. 5 may include one or more elements, processes and/or devices in addition to, or instead of, those illustrated in FIGS. 4-5, and/or may include more than one of any or all of the illustrated elements, processes and devices.

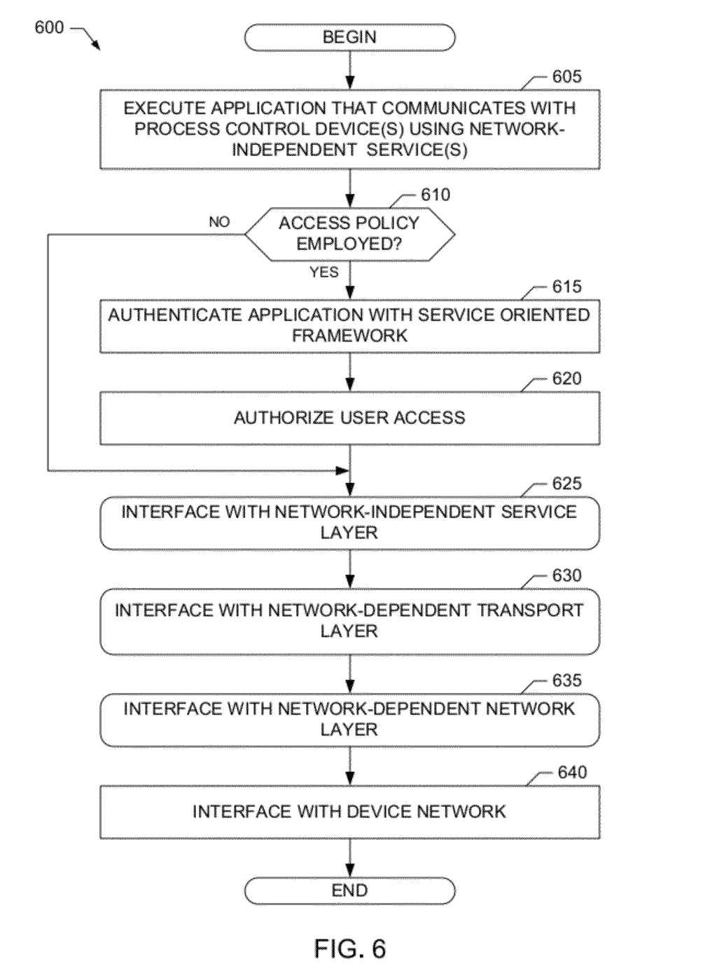

Flowcharts representative of example processes that may be executed to implement the example process control environment 100, the example FDI server 106, the example client device 104, the example application interface 404, the example processor 408, the example network interface 412, the example client interface 504, the example processor 508, the example service interface 512 and/or, more generally, the service oriented framework 200 are shown in FIGS. 6-10. In these examples, the process represented by each flowchart may be implemented by one or more programs comprising machine readable instructions for execution by a processor, such as the processor 1102 shown in the example processing system 1100 discussed below in connection with FIG. 11. Alternatively, the entire program or programs and/or portions thereof implementing one or more of the processes represented by the flowcharts of FIGS. 6-10 could be executed by a device other than the processor 1102 (e.g., such as a controller and/or any other suitable device) and/or embodied in firmware or dedicated hardware (e.g., implemented by an ASIC, a PLD, an FPLD, discrete logic, etc.). Also, one or more of the processes represented by the flowchart of FIGS. 6-10, or one or more portion(s) thereof, may be implemented manually. Further, although the example processes are described with reference to the flowcharts illustrated in FIGS. 6-10, many other techniques for implementing the example methods and apparatus described herein may alternatively be used. For example, with reference to the flowcharts illustrated in FIGS. 6-10, the order of execution of the blocks may be changed, and/or some of the blocks described may be changed, eliminated, combined and/or subdivided into multiple blocks.

As mentioned above, the example processes of FIGS. 6-10 may be implemented using coded instructions (e.g., computer readable instructions) stored on a tangible computer readable medium such as a hard disk drive, a flash memory, a read-only memory (ROM), a CD, a DVD, a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 6-10 may be implemented using coded instructions (e.g., computer readable instructions) stored on a non-transitory computer readable medium, such as a flash memory, a ROM, a CD, a DVD, a cache, a random-access memory (RAM) and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. Also, as used herein, the terms “computer readable” and “machine readable” are considered equivalent unless indicated otherwise.

An example process 600 that may be executed to implement the example service oriented framework 200 of FIG. 2 is illustrated in FIG. 6. The example process 600 may be executed at predetermined intervals, based on an occurrence of a predetermined event, etc., or any combination thereof. The process 600 of FIG. 6 is described from the perspective of being executed by the FDI server 106 of FIGS. 1 and/or 4 to support the process control application 202 as executed by the client device 104 of FIGS. 1 and/or 5. Thus, with reference to the preceding figures, the process 600 of FIG. 6 begins execution at block 605 at which the client device 104 executes a process control application 202 that is to communicate with one or more field devices in one or more process control systems using one or more network independent services 228 (also referred to as network agnostic services, device independent services, device agnostic services, etc.) provided by the service oriented framework 200. For example, at block 605 the process control application can use one or more of the request-response service 304, the publish-subscribe service 308, the event service 312, the directory service 316 and/or the write service 320, all of FIG. 3, to communicate with the one or more field devices.

At block 610, the service oriented framework 200 executing on the FDI server 106 determines whether an access policy is employed. If an access policy is employed (block 610), at block 615 the authentication module 248 of the service oriented framework 200 authenticates the process control application 202 for use with the service oriented framework 200. Additionally, at block 620 the authorization module 250 of the service oriented framework 200 authorizes a user of the process control application 202 to provide user-specific levels of access (e.g., read-only, read and write, no access, administration access, etc.) to the services 228 provided by the service oriented framework 200.

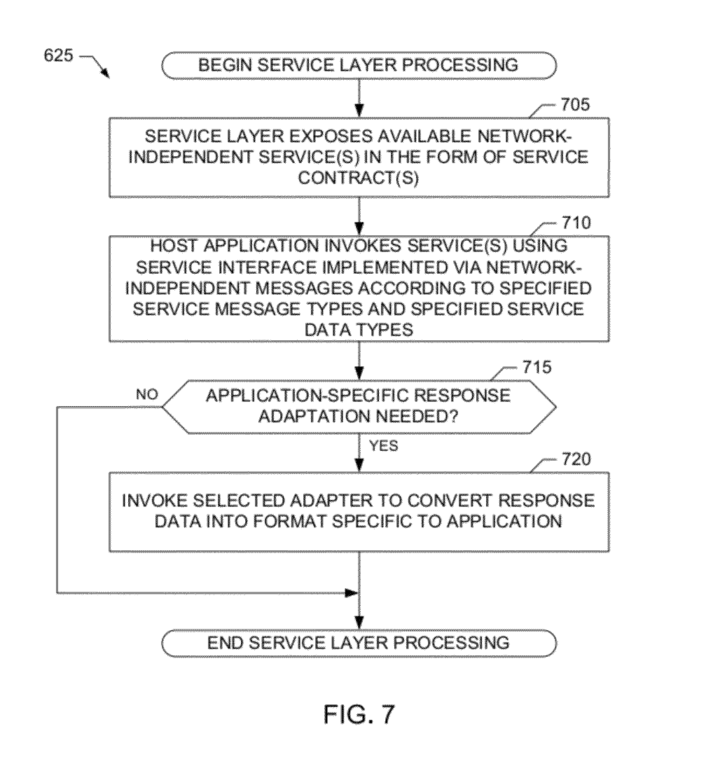

At block 625, the process control application 202 interfaces with the network independent service layer 212 of the service oriented framework 200. The service layer 212 is referred to as being network independent because it provides service(s) 228 for communicating with field devices in process control systems wherein the services are not dependent on any particular process control network protocol. An example process that may be used to implement the processing at block 625 is illustrated in FIG. 7, which is described in greater detail below.

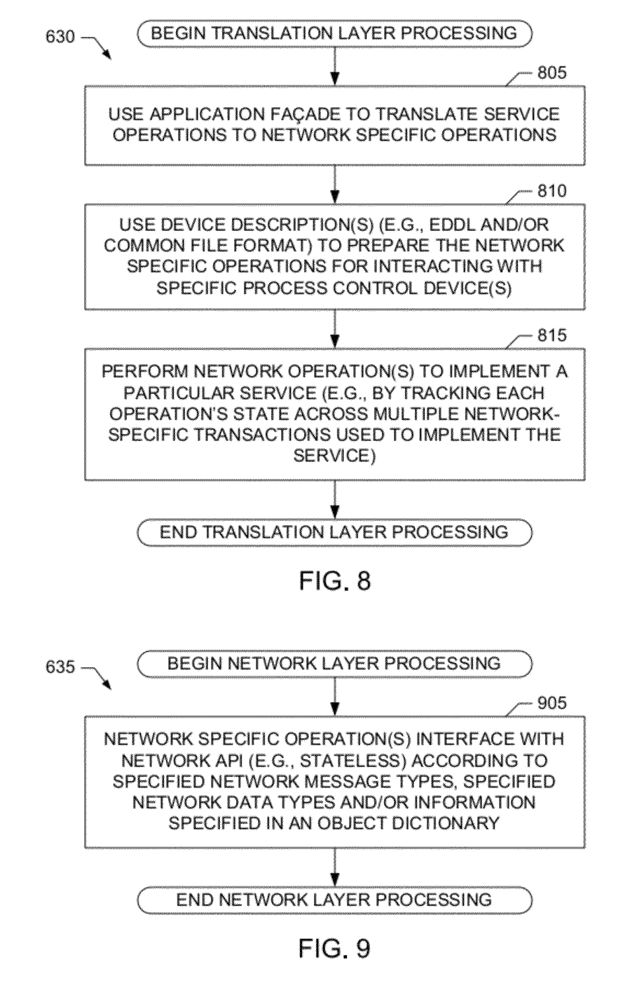

At block 630, the network independent service layer 212 of the service oriented framework 200 interfaces with a network dependent translation layer 214 of the service oriented framework 200. The translation layer 214 is referred to as being network dependent because each translation layer 214 included in the service oriented framework 200 translates the network independent services 228 provided by the service layer 212 to respective sequences of network operations that are specific to (e.g., dependent on) a particular process control network protocol. An example process that may be used to implement the processing at block 630 is illustrated in FIG. 8, which is described in greater detail below.

At block 635, the network dependent translation layer 214 of the service oriented framework 200 interfaces with a corresponding network dependent network layer 216 of the service oriented framework 200. The network layer 216 is referred to as being network dependent because each network layer 216 included in the service oriented framework 200 provides the sequences of network operations determined by its respective translation layer 214 with a network interface targeted to the particular process control network protocol supported by the translation layer 214. An example process that may be used to implement the processing at block 635 is illustrated in FIG. 9, which is described in greater detail below.

At block 640, one or more network layers 216 of the service oriented framework 200 are used to interface with one or more particular device networks 210 implementing one or more process control systems containing the one or more field devices with which the process control application 202 is to communicate. Execution of the example process 600 then ends.

An example process 625 that may be executed to implement example service layer processing at block 625 of FIG. 6 is illustrated in FIG. 7. With reference to the preceding figures, the process 625 of FIG. 7 begins execution at block 705 at which the service layer 212 of the service oriented framework 200 exposes available network independent service(s) 228 in the form service contract(s) accessible by process control application(s) 202. At block 710, a process control application 202 invokes one or more of the services 228 using one or more of the service interfaces 220, each service interface 220 being associated with a respective service 228. For example, each service interface 220 is a message-based service interface that employs network independent messages defined using the service message types 222 and the service data types 224 specified by the service oriented framework 200.

At block 715, the service layer 212 determines whether a response (e.g., device data, events, etc.) being returned to the process control application 202 by a field device in response to the process control application 202 invoking a particular service 228 at block 710 needs to be adapted to an application specific format. If application specific response adaptation is needed (block 715), the service layer 212 invokes a selected adapter 226 to adapt the response data to a format specific to the process control application 202. Execution of the example process 625 then ends.

An example process 630 that may be executed to implement example translation layer processing at block 630 of FIG. 6 is illustrated in FIG. 8. With reference to the preceding figures, the process 630 of FIG. 8 begins execution at block 805 at which a particular translation layer 214 of the service oriented framework 200 that supports a process control network protocol used to communicate with a particular field device is invoked by the service layer 212 of the service oriented framework 200. Additionally, at block 805 the application façade 229 included in the particular translation layer 214 is used to translate the service operations implementing a particular service 228 provided by the service layer 212 into a respective sequence of one or more network operations 230 for implementing the service 228. As described above, the service operations implementing a particular service 228 are independent of any process control network protocol, whereas the sequence of network operations 230 are specific to a particular process control network protocol used to implement a device network 210 (e.g., and, more generally, a process control system) containing a particular field device with which the service 228 is to communicate.

At block 810, the translation layer 214 uses the device description files 208 (e.g., in the EDDL format 232 and/or the common file format 234) to prepare the sequence of network operations 230 for interacting with one or more specific field device(s) with which the service 228 is to communicate.

At block 815, the translation layer 214 performs the sequence of network operations 230 (e.g., by invoking a corresponding network layer 216) and maintains a state of the sequence of network operations 230 as they are performed. The state maintained by the translation layer 214 at block 810 can be used to track which of the sequence of network operations 230 has been performed and which remain to be performed at a given time to implement the service 228. After the sequence of network operations 230 has been performed, execution of the example process 630 then ends.

An example process 635 that may be executed to implement example network layer processing at block 635 of FIG. 6 is illustrated in FIG. 9. With reference to the preceding figures, the process 635 of FIG. 9 begins execution at block 905 at which a particular network layer 216 is invoked to enable a sequence of network operations determined by a corresponding translation layer 214 to interface with the appropriate network API 240 defined for the device network 210 containing the field device(s) with which the sequence of network operations 230 are to be performed. For example, the network API 240 used at block 905 supports various network message types 242, network data types 244 and possibly one or more object dictionaries 246 specific to a particular process control network protocol 236 employed by the device network 210 containing the field device(s) with which the sequence of network operations 230 are to be performed. After process completes at block 905, execution the example process 635 then ends.

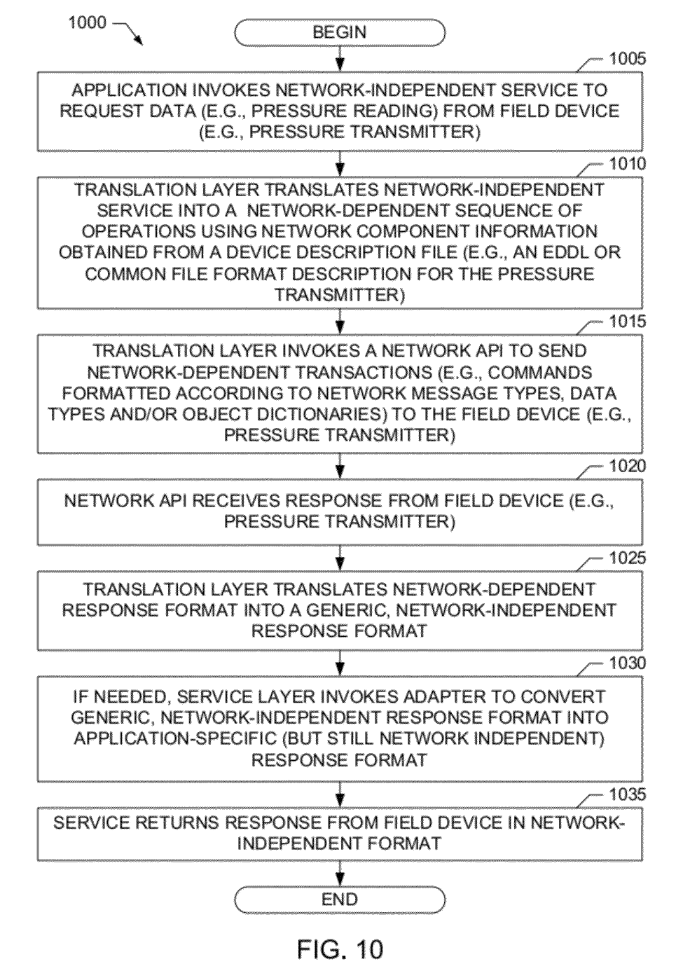

An example process 1000 illustrating an example operation of the service framework 200 of FIG. 2 to enable a client application 202 to communicate with a field device in a process control system 102 is illustrated in FIG. 10. With reference to the preceding figures, at block 1005 the client application invokes a network independent service 228 exposed by the service layer 212 and having a generic (e.g., network independent) interface 220 to request reading data (e.g., monitored pressure) from a field device (e.g., a pressure transmitter). At block 1010, the translation layer 214 translates the network independent service 228 into a network dependent sequence of network operations 230 to implement the service 228 in a particular device network 210 containing the field device. For example, at block 1010 the application façade 229 of the translation layer 214 uses network component information obtained from a device description file 208 to prepare the sequence of network operations 230. (For example, the device description file 208 could be in an EDDL description 232 or a common file format description 234 of the pressure transmitter).

At block 1015, the translation layer 214 invokes a network API 240 provided by a network layer 216 associated with the translation layer 214 to send network dependent transactions (e.g., commands formatted according to the network message types 242, network data types 244 and/or object dictionaries 246) to the field device (e.g., the pressure transmitter) in accordance with the sequence of network operations 230 determined at block 1010. Sometime later, at block 1020 the network API 240 receives a response (e.g., containing measured pressure data) from the field device (e.g., the pressure transmitter). At block 1025, the translation layer 214 translates the network dependent format of the response received at block 1015 into a generic, network independent response format, which is provided to the service layer 212. At block 1030, the service layer 212 invokes an adapter 226, if needed, to convert the generic, network independent format of the response prepared at block 1025 into a format that is still network independent, but which is specific to the application 202. At block 1035, the service layer returns the response (e.g., using the service interface 220 of the service 220 invoked at block 1005) to the application 202. Execution of the example process 1000 then ends.

FIG. 11 is a block diagram of an example processing system 1100 capable of implementing the FDI server 106 and the service oriented framework 200 of FIG. 2. The example processing system 1100 may additionally or alternatively be used to implement the client 104 to execute the client applications 120, 202, etc. The computer 1100 can be, for example, a server, a personal computer, a mobile phone (e.g., a cell phone), a personal digital assistant (PDA), an Internet appliance, or any other type of computing device.

The example processor system 1100 includes a processor 1102 having associated memories, such as a random access memory (RAM) 1104, a read only memory (ROM) 1106 and a flash memory 1108. The processor 1102 may execute, among other things, machine readable instructions to implement the processes represented in FIG. 6-10. The processor 1102 may be any type of processing unit, such as one or more Intel® microprocessors from the Pentium® family, the Itanium® family and/or the XScale® family, one or more microcontrollers from the ARM® and/or PIC® families of microcontrollers, etc. Of course, other processors from other families are also appropriate.

The RAM 1104, the ROM 1106, and/or the flash memory 1108 may store machine-readable instructions that implement the process 900 of FIG. 9. The RAM 1104 may be implemented by Synchronous Dynamic Random Access Memory (SDRAM), Dynamic Random Access Memory (DRAM), RAMBUS Dynamic Random Access Memory (RDRAM) and/or any other type of random access memory device. The flash memory 1108 of the illustrated example includes a boot block 1110. Access to the RAM 1104, the ROM 1106, and the flash memory 1108 is typically controlled by a memory controller (not shown).

The processor 1102 is coupled to an interface, such as a bus 1112 to which other components may be interfaced. In the illustrated example, the components interfaced to the bus 1112 include an input device 1114, a display device 1116, a mass storage device 1118 and a removable storage device drive 1120. The removable storage device drive 1120 may include associated removable storage media 1122 such as magnetic or optical media.

The input device(s) 1114 permit a user to enter data and commands into the processor 1102. The input device 1114 may be implemented using any one or more of a keyboard, a mouse, a touch screen, a track pad, a barcode scanner or any other device that enables a user to provide information to the processor 1102.

The display device 1116 may be, for example, a liquid crystal display (LCD) monitor, a cathode ray tube (CRT) monitor or any other suitable device that acts as an interface between the processor 1102 and a user. The display device 1116 as pictured in FIG. 11 includes any additional hardware required to interface a display screen to the processor 1102.

The mass storage device 1118 may be, for example, a conventional hard drive or any other magnetic or optical media that is readable by the processor 1102.

The removable storage device drive 1120 may, for example, be an optical drive, such as a compact disk-recordable (CD-R) drive, a compact disk-rewritable (CD-RW) drive, a digital versatile disk (DVD) drive or any other optical drive. It may alternatively be, for example, a magnetic media drive. The removable storage media 1122 is complimentary to the removable storage device drive 1120, inasmuch as the media 1122 is selected to operate with the drive 1120. For example, if the removable storage device drive 1120 is an optical drive, the removable storage media 1122 may be a CD-R disk, a CD-RW disk, a DVD disk or any other suitable optical disk. On the other hand, if the removable storage device drive 1120 is a magnetic media device, the removable storage media 1122 may be, for example, a diskette or any other suitable magnetic storage media.

Coded instructions to implement one or more of the process of FIGS. 6-10 may be stored in the RAM 1104, in the ROM 1106, in the flash memory 1108, in the mass storage device 1118, and/or on the removable storage media 1122 such as a CD or DVD.

As an alternative to implementing the methods and/or apparatus described herein in a system such as the processing system of FIG. 11, the methods and or apparatus described herein may be embedded in a structure such as a processor and/or an ASIC (application specific integrated circuit).

From the foregoing disclosure, it will be appreciated that the example methods, apparatus and articles of manufacture described herein can be used to implement a service oriented framework for communicating with devices in a process control network. The example service oriented framework disclosed herein can provide benefits over prior process control solutions, at least under some circumstances. For example, in the service oriented framework disclosed herein, functions, features and flexibility may be able to be added to the system by vendors without having an impact on existing applications. As another example, the service oriented framework disclosed herein may reduce overall system complexity because each process control application only needs to know how to communicate through services, whereas specific process control network/device protocols used to communicate with devices are provided at a lower level in the framework. As yet another example, process control applications can be changed independently of the underlying device networks because the service oriented framework disclosed herein exposes a generic, network independent interface for communication with the device networks, allowing application changes, updates, and replacements to be based on only this same, network independent interface. As still another example, the service oriented framework disclosed herein allows each process control application to support only a single connection to the framework instead of multiple connections to support each network type. As another example, the service oriented framework disclosed herein permits services to be added to support the capabilities provided by the process control device networks, and EDDL descriptions can define which services are provided by a particular device. As yet another example, the service oriented framework disclosed herein includes well-defined interfaces between layers that can be used as conformance test points for validating process control system implementations. As still another example, the network-independent service interfaces of the service oriented framework disclosed herein can allow customers to purchase devices from any supplier and plug them into the architecture with the expectation that process control applications will continue to communicate with the different devices.

Finally, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method to communicate with a device in a process control system, the method comprising:
invoking a service to communicate with the device in the process control system, the service having a generic interface that is independent of a process control network protocol used to implement the process control system;
translating the service into one or more network operations to implement the service, the network operations being specific to the process control network protocol used to implement the process control system; and
using a network interface specific to the process control network protocol used to implement the process control system to communicate with the device in accordance with the one or more network operations.

2. A method as defined in claim 1 wherein the service is exposed as a service contract by a service layer providing a plurality of services, each of the plurality of services is independent of the process control network protocol used to implement the process control system, and each of the plurality of services supports communication with devices in a plurality of different process control systems implemented using a plurality of different process control network protocols.

3. A method as defined in claim 1 wherein invoking the service comprises using one or more of a plurality of messages defining a message based service interface to invoke the service, the plurality of messages comprising a plurality of service message types and a plurality of service data types, the plurality of service message types and the plurality of service data types being independent of any process control network protocol.

4. A method as defined in claim 1 wherein translating the service into one or more network operations to implement the service comprises:
translating the service into a sequence of network operations specific to the process control network protocol; and
maintaining a state of the sequence of network operations to track which of the sequence of network operations has been performed to implement the service.

5. A method as defined in claim 1 wherein translating the service into one or more network operations to implement the service comprises reading a device description for the device to prepare the one or more network operations.

6. A method as defined in claim 5 wherein the device description is stored in at least one of an electronic device description language or a common file format.

7. A method as defined in claim 1 wherein the network specific interface comprises a network application programming interface comprising at least one of a plurality of network message types, a plurality of network data types or an object dictionary specific to the process control network protocol used to implement the process control system.

8. A method as defined in claim 1 further comprising:
receiving a response from the device, the response being in a first format specific to the process control network protocol used to implement the process control system;
translating the response from the first format to a second format independent of the process control network protocol used to implement the process control system; and
invoking an adapter to convert the response from the second format to a third format specific to an application that is to receive the response.

9. A method as defined in claim 1 further comprising authenticating an application prior to invoking the service.

10. A method as defined in claim 1 further comprising restricting communication with the device based on a user authorization performed when invoking the service.

11. A method as defined in claim 1 wherein the service corresponds to at least one of:
a first service to send a message to a device and to receive a corresponding response from the device;
a second service to subscribe to published data returned by the device;
a third service to received events returned by the device;
a fourth service to obtain information describing the process control system and a plurality of devices, including the device, implementing the process control system; and
a fifth service to write control parameter values to the device.

12. A method as defined in claim 1 wherein the service is invoked using one or more messages sent asynchronously, and the network interface implements synchronous polling to obtain data from the device.

13. A tangible article of manufacture storing machine readable instructions which, when executed, cause a machine to at least:
invoke a service to communicate with a device in a process control system, the service having a generic interface that is independent of a process control network protocol used to implement the process control system;
translate the service into one or more network operations to implement the service, the network operations being specific to the process control network protocol used to implement the process control system; and
use a network interface specific to the process control network protocol used to implement the process control system to communicate with the device in accordance with the one or more network operations.

14. A tangible article of manufacture as defined in claim 13 wherein the service is exposed as a service contract by a service layer providing a plurality of services, each of the plurality of services is independent of the process control network protocol used to implement the process control system, each of the plurality of services supports communication with devices in a plurality of different process control systems implemented using a plurality of different process control network protocols, and wherein the machine readable instructions, when executed, further cause the machine is to invoke the service using one or more of a plurality of messages defining a message based service interface to invoke the service, the plurality of messages comprising a plurality of service message types and a plurality of service data types, the plurality of service message types and the plurality of service data types being independent of any process control network protocol.

15. A tangible article of manufacture as defined in claim 13 wherein the machine readable instructions, when executed, further cause the machine to translate the service into one or more network operations to implement the service by:
translating the service into a sequence of network operations specific to the process control network protocol;
reading a device description for the device to prepare the sequence of network operations; and
maintaining a state of the sequence of network operations to track which of the sequence of network operations has been performed to implement the service.

16. A tangible article of manufacture as defined in claim 13 wherein the network specific interface comprises a network application programming interface comprising at least one of a plurality of network message types, a plurality of network data types or an object dictionary specific to the process control network protocol used to implement the process control system.

17. An apparatus to communicate with field devices in process control systems, the apparatus comprising:
a processor to implement a service oriented framework for communicating with a plurality of field devices in a plurality of process control systems implemented using a plurality of different process control network protocols, the service oriented framework including:
a service layer implementing a plurality of services to communicate with the plurality of field devices, each service having a respective generic interface that is independent of any of the plurality of process control network protocols used to implement the plurality of process control systems;
a plurality of translation layers, each respective translation layer to translate each service in the plurality of services into a respective sequence of network operations to implement the respective service, the respective sequence of network operations being specific to a particular process control network protocol associated with the respective translation layer; and
a plurality of network layers associated respectively with the plurality of translation layers to provide a plurality of network interfaces specific to each of the plurality of process control network protocols used to implement the plurality of process control systems; and
an interface to communicatively couple an application implemented by a client device with the service layer implemented by the processor.

18. An apparatus as defined in claim 17 wherein each service is exposed as a respective service contract by the service layer, each service supports communication with the plurality of field devices in the plurality of different process control systems implemented using the plurality of different process control network protocols, and each service is invoked using one or more of a plurality of messages defining a message based service interface to invoke each of the plurality of services, the plurality of messages comprising a plurality of service message types and a plurality of service data types, the plurality of service message types and the plurality of service data types being independent of any process control network protocol.

19. An apparatus as defined in claim 17 wherein a first translation layer translates a first service into a first sequence of network operations by:
reading a device description for a first field device with which the first service is to communicate to prepare the first sequence of network operations; and
maintaining a state of the first sequence of network operations to track which of the first sequence of network operations has been performed to implement the first service.

20. An apparatus as defined in claim 17 wherein a first network specific interface provided by a first network layer comprises a network application programming interface comprising at least one of a plurality of network message types, a plurality of network data types or an object dictionary specific to a first process control network protocol used to implement a first process control system.
